(19) United States
(12) Patent Application Publication
(10) Pub. No.: US 2004/0213949 A1
(43) Pub. Date: Oct. 28, 2004

(54) Magnetic disk and method of producing the same

(75) Inventors: Teiichiro Umezawa, Tokyo (JP); Keiji Moroishi, Singapore (SG)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION, HOYA MAGNETICS SINGAPORE PTE. LTD.

(21) Appl. No.: 10/762,574

(22) Filed: Jan. 23, 2004

(30) Foreign Application Priority Data
Jan. 23, 2003 (JP) 14185/2003

(51) Int. Cl. B32B 3/02

(52) U.S. Cl. 428/65.3; 428/694 TR

(57) ABSTRACT

A magnetic disk 10 has a disk substrate 1 and an exchange coupling film 5 which is formed thereon and which has a first magnetic layer 5a, a second magnetic layer 5c, and a spacer layer 5b interposed between the first and the second magnetic layers 5a and 5c. The spacer layer 5b has a surface roughness Ra not greater than the thickness of the spacer layer 5b, where Ra is representative of a center-line-mean roughness.

This application claims priority to prior Japanese application JP 2003-14185, the disclosure of which is incorporated herein by reference.

### BACKGROUND OF THE INVENTION

This invention relates to a magnetic disk to be loaded in a magnetic disk apparatus, such as a HDD (hard disk drive), for recording information.

Following the recent development of the IT (information technology) industry, the information recording technology, in particular, the magnetic recording technology is requested to achieve dramatic technical innovation. For example, for a magnetic disk to be loaded in a magnetic disk apparatus such as a HDD, it is required to achieve an information recording density of 20 Gbit/inch² or more. It is known that, at such a high recording density, a defect called thermal fluctuation may be caused to occur. The thermal fluctuation is a phenomenon in which a recorded signal recorded on the magnetic disk is attenuated with the lapse of time. Presumably, the thermal fluctuation results from the fact that magnetization of the recorded signal is susceptible to thermal magnetic aftereffect (magnetic aftereffect owing to thermal fluctuation) as a result of miniaturization of magnetic grains in a magnetic layer for the purpose of achieving such a high recording density. In order to avoid the thermal fluctuation, Japanese Patent Application Publication (JP-A) No. 2001-56924 discloses the technique intended to improve the thermal stability of written bits by introducing an exchange layer structure into a magnetic recording medium.

However, if the information recording density exceeds 40 Gbit/inch², it is difficult to sufficiently suppress the thermal fluctuation merely by introducing the exchange layer structure. As a result of the study by the present inventors, it has been found out that, in order to achieve the recording density of 40 Gbit/inch², a S/N (Signal-to-noise) ratio must be improved and, for this purpose, the grain size of magnetic grains is preferably as small as about 80% of that required to achieve the recording density of 20 Gbit/inch². However, if the grain size is miniaturized to such an extent, the thermal stability factor KuV/kT becomes excessively small. As a consequence, it is no longer possible to sufficiently prevent the thermal fluctuation merely by introducing the exchange layer structure known in the art. Herein, Ku represents the magnetic anisotropy constant, V, the activated volume, k, the Boltzmann constant, T, the temperature.

In order to solve the above-mentioned problem, various advanced techniques have been proposed as improvements of the technique disclosed in the above-mentioned publication. For example, as the advanced techniques, it is proposed to adjust the concentration of an element used as a magnetic layer (for example, to increase the concentration of platinum (Pt) of the magnetic layer), to adjust the thickness of the magnetic layer, to use a magnetic layer having a multilayer structure, and to increase the coercive force (Hc). These techniques may be used alone or in combination. Each of the above-mentioned advanced techniques is regarded as one of the approaches for improving the thermal stability factor KuV/kT by increasing the magnetic anisotropy constant Ku of the magnetic recording medium or by increasing the activated volume V.

In the existing advanced techniques mentioned above, the thermal stability factor can be improved by increasing Ku and/or V. In this event, however, there arises another problem of an increase of medium noise N. If the thermal stability factor is improved so that the resistance against thermal fluctuation (hereinafter referred to as thermal fluctuation resistance) is improved, the medium noise N is increased so that the S/N ratio is decreased. Thus, the existing advanced techniques suffer the trade-off between the thermal fluctuation resistance and the S/N ratio. Therefore, a higher recording density can be achieved under an extremely limited condition and stable mass-production of the magnetic disk is difficult. Thus, in the existing advanced techniques, it is practically difficult to achieve a higher recording density of 40 Gbit/inch² or more.

### SUMMARY OF THE INVENTION

It is an object of this invention to provide a magnetic disk prevented from thermal fluctuation even at a recording density of 40 Gbit/inch² or more and having a high S/N ratio.

This invention achieves the object of stably obtaining a magnetic disk high in thermal fluctuation resistance without decreasing a S/N ratio and has been completed by the present inventors according to a unique approach different from that in each of the existing advanced techniques.

Based on the knowledge obtained as a result of the devoted studies, the present inventors completed the invention having each of the following structures.

Structure 1

A magnetic disk comprising a disk substrate having a substrate surface and an exchange coupling film on the substrate surface, the exchange coupling film comprising a first magnetic layer, a second magnetic layer farther from the substrate surface than the first magnetic layer, and a spacer layer interposed between the first and the second magnetic layers and having a principal surface nearer to the second magnetic layer than the first magnetic layer, the principal surface of the spacer layer having a surface roughness Ra which is not greater than a thickness of the spacer layer, where Ra is representative of a center-line-mean roughness.

The center-line-mean roughness Ra is defined in Japanese Industrial Standard JIS B0601 and is disclosed in, for example, U.S. Pat. No. 6,544,893B2.

Structure 2

A magnetic disk comprising a disk substrate having a substrate surface and an exchange coupling film on the substrate surface, the exchange coupling film comprising a first magnetic layer, a second magnetic layer farther from the substrate surface than the first magnetic layer, and a spacer layer interposed between the first and the second magnetic layers and having a principal surface nearer to the second magnetic layer than the first magnetic layer, the principal surface of the spacer layer having a surface roughness Ra which is not greater than 0.5 nm, where Ra is representative of a center-line-mean roughness.

Structure 3

A magnetic disk comprising a disk substrate having a substrate surface and an exchange coupling film on the substrate surface, the exchange coupling film comprising a first magnetic layer, a second magnetic layer farther from the substrate surface than the first magnetic layer, and a spacer layer interposed between the first and the second magnetic layers, the substrate surface of the disk substrate having a surface roughness Ra which is not greater than a thickness of the spacer layer, where Ra is representative of a center-line-mean roughness.

Structure 4

A magnetic disk comprising a disk substrate having a substrate surface and an exchange coupling film on the substrate surface, the exchange coupling film comprising a first magnetic layer, a second magnetic layer farther from the substrate surface than the first magnetic layer, and a spacer layer interposed between the first and the second magnetic layers, the substrate surface of the disk substrate having a surface roughness Ra which is not greater than 0.5 nm, where Ra is representative of a center-line-mean roughness.

Structure 5

A magnetic disk as described in any one of structures 1 through 4, wherein the spacer layer is made of a high-melting-point material higher in melting point than a material of any one of the first and the second magnetic layers.

Structure 6

A magnetic disk as described in any one of structures 1 through 5, wherein each of the first and the second magnetic layers has an epitaxial relationship with the spacer layer.

Structure 7

A magnetic disk as described in any one of structures 1 through 6, wherein the exchange coupling film causes antiferromagnetic coupling.

Structure 8

A method of producing a magnetic disk comprising a disk substrate having a substrate surface and an exchange coupling film on the substrate surface, the exchange coupling film comprising a first magnetic layer, a second magnetic layer farther from the substrate surface than the first magnetic layer, and a spacer layer interposed between the first and the second magnetic layers, the method comprising the steps of:

preliminarily obtaining a relationship between a surface roughness Ra of the substrate surface of the disk substrate and signal attenuation or decay of the magnetic disk owing to thermal fluctuation and determining the surface roughness Ra of the substrate surface of the disk substrate with reference to the relationship so that the signal attenuation has a desired level.

Structure 9

A method of producing a magnetic disk comprising a disk substrate having a substrate surface and an exchange coupling film on the substrate surface, the exchange coupling film comprising a first magnetic layer, a second magnetic layer farther from the substrate surface than the first magnetic layer, and a spacer layer interposed between the first and the second magnetic layers, the method comprising the steps of:

preliminarily obtaining a relationship between a surface roughness of the substrate surface of the disk substrate and attenuation owing to thermal fluctuation when a signal is recorded on the magnetic disk;

determining a desired surface roughness of the substrate surface of the disk substrate with reference to the relationship so that the attenuation of the signal has a desired level;

producing the disk substrate having the substrate surface which has the desired surface roughness; and

forming the exchange coupling film on the substrate surface of the disk substrate which has the desired surface roughness.

Structure 10

A method of producing a magnetic disk comprising a disk substrate having a substrate surface and an exchange coupling film on the substrate surface, the exchange coupling film comprising a first magnetic layer, a second magnetic layer farther from the substrate surface than the first magnetic layer, and a spacer layer interposed between the first and the second magnetic layers and having a principal surface nearer to the second magnetic layer than the first magnetic layer, the method comprising the steps of:

preliminarily obtaining a relationship between a surface roughness of the principal surface of the spacer layer and attenuation owing to thermal fluctuation when a signal is recorded on the magnetic disk;

determining a desired surface roughness of the principal surface of the spacer layer with reference to the relationship so that the attenuation of the signal has a desired level; and

depositing the spacer layer so that the spacer layer has the principal surface which has the desired surface roughness.

Structure 11

A method of producing a magnetic disk comprising a disk substrate having a substrate surface and an exchange coupling film on the substrate surface, the exchange coupling film comprising a first magnetic layer, a second magnetic layer farther from the substrate surface than the first magnetic layer, and a spacer layer interposed between the first and the second magnetic layers and having a principal surface nearer to the second magnetic layer than the first magnetic layer, the method comprising the step of:

depositing the spacer layer by sputtering so that the principal surface of the spacer layer has a surface roughness Ra which is not greater than a thickness of the spacer layer, where Ra is representative of a center-line-mean roughness.

Structure 12

A method of producing a magnetic disk as described in structure 9, wherein the spacer layer is deposited by sputtering at a deposition rate within a range not higher than 1.2 nm/sec.

Structure 13

A method of producing a magnetic disk as described in structure 11 or 12, wherein the spacer layer is deposited by sputtering at a deposition temperature within a range not higher than 260° C.

### BRIEF DESCRIPTION OF THE DRAWING

FIG. 1 is a schematic sectional view of a magnetic disk according to an embodiment of this invention; and

FIG. 2 is a graph showing the relationship between each of the surface roughness Ra of a disk substrate and the surface roughness Ra of a spacer layer and the signal attenuation owing to thermal fluctuation.

### DESCRIPTION OF THE PREFERRED EMBODIMENTS

The exchange coupling film referred to in this invention comprises the first magnetic layer, the second magnetic layer, and the spacer layer interposed between the first and the second magnetic layers as set forth in structure 1. The spacer layer comprises a film which serves to cause exchange coupling between the first and the second magnetic layers.

The exchange coupling is induced by exchange interaction. The exchange interaction is a phenomenon that the exchange integral or the exchange energy is varied depending upon the distance between magnetic spin moments. The exchange interaction is an interaction explained by quantum mechanics and is a microscopic interaction such that the exchange integral or the exchange energy is varied even if the distance between the magnetic spin moments is changed only slightly, by about 0.05 nm to 0.1 nm.

The present inventors have pursued intense study in order to achieve the above-mentioned object. As a result, it has been found out that, in order to prevent the thermal fluctuation without increasing medium noise N, the degree of exchange coupling between the first and the second magnetic layers must be controlled to be precisely constant in a microscopic region on the surface of the magnetic disk. According to the study of the present inventors, if the distance between the first and the second magnetic layers can be controlled to be precisely constant or uniform even in a microscopic region on the surface of the magnetic disk, the degree of exchange coupling between the first and the second magnetic layers can be precisely constant even in a microscopic region on the surface of the magnetic disk. This makes it possible to suppress the in-plane distribution of the thermal fluctuation in a microscopic region. If the in-plane distribution of the thermal fluctuation is suppressed, those clusters excessively susceptible to thermal fluctuation can be reduced. Therefore, as a statistical sum, the magnetic disk as a whole is improved in thermal fluctuation resistance.

According to this invention, superior thermal fluctuation resistance is achieved without adjusting the composition, the thickness, and the coercive force Hc of the magnetic layer, i.e., without increasing the medium noise N. Therefore, without causing the tradeoff between the thermal fluctuation resistance and the S/N ratio which is suffered by the approaches in the existing advanced techniques, a magnetic disk suitable for a higher recording density can be obtained. Without the limitation due to the above-mentioned tradeoff, a wider range of design selection upon mass-production is assured as compared with the existing advanced techniques. Thus, it is possible to mass-produce a stable and high-quality magnetic disk at a low cost.

As described above, the exchange coupling acting between the first and the second magnetic layers is induced by the spacer layer interposed therebetween. By selecting a predetermined value as the thickness of the spacer layer, the distance between the first and the second magnetic layers is controlled to thereby achieve a desired degree of exchange coupling.

The present inventors studied about an inhibiting factor against the constant or uniform distance between the first and the second magnetic layers in a microscopic region and found out that the surface roughness of the principal surface (namely, an upper surface) of the spacer layer is the inhibiting factor. It is supposed that, if the surface roughness of the principal surface (or the upper surface) of the spacer layer is large, for example, relative to the thickness of the spacer layer, the distance between the first and the second magnetic layers is varied depending upon the irregularities of the spacer layer in the microscopic region so that the variation in exchange coupling is caused. Therefore, it is supposed that the variation in exchange coupling can be suppressed if the surface roughness Ra of the spacer layer is not greater than the thickness of the spacer layer. As a consequence, excellent thermal fluctuation resistance can be obtained. In this invention, the surface roughness Ra is an arithmetic average roughness Ra defined as the center-line-mean roughness in Japanese Industrial Standard JIS B0601 and is disclosed in U.S. Pat. No. 6,544,893B2.

It is also supposed that, if the surface roughness Ra of the principal surface (or the upper surface) of the spacer layer is not greater than 0.5 nm, the variation in exchange coupling can similarly be suppressed. As a consequence, excellent thermal fluctuation resistance can be obtained. Furthermore, it is supposed that, if the surface roughness Ra of the principal surface (or the upper surface) of the spacer layer is not greater than the thickness of the spacer layer and is not greater than 0.5 nm, the variation in exchange coupling can further be suppressed. As a consequence, much excellent thermal fluctuation resistance can be achieved.

Furthermore, if the surface roughness Ra of the principal surface (or the upper surface) of the spacer layer is not greater than 0.4 nm, the effect of this invention is more remarkable.

In this invention, it is preferable that, in addition to limitation of the surface roughness Ra of the principal surface (or the upper surface) of the spacer layer, another surface roughness Rmax of the principal surface (or the upper surface) of the spacer layer is limited to a range not greater than 6 nm. Herein, the surface roughness Rmax is a maximum height Rmax (Ry) representative of a difference between a highest point and a lowest point of the the principal surface (or the upper surface) of the spacer layer defined also in Japanese Industrial Standard JIS B0601 and is also disclosed in U.S. Pat. No. 6,544,893B2.

By simultaneously satisfying both of the requirements for the arithmetic average roughness Ra and the maximum height Rmax of the spacer layer, the roughness higher than the average roughness, for example, the surface roughness of the spacer layer by an abnormal protrusion can advantageously be suppressed. Furthermore, it is preferable that the surface roughness Rmax of the spacer layer is not greater than 4 nm because the effect of this invention becomes more remarkable.

In this invention, it is unnecessary to determine the lower limit of the surface roughness Ra or Rmax. As the spacer layer has a flatter and smoother surface, the effect of this invention is more remarkably exhibited. However, a practical lower limit may be determined, for example, in order to avoid degradation in HDI (Head Disk Interface) characteristics. In this point of view, it is practically preferable that the surface roughness Ra of the spacer layer has a lower limit of, for example, 0.1 nm and the surface roughness Rmax has a lower limit of, for example, 1 nm.

As the surface roughness in this invention, it is preferable to use a value measured by an atomic force microscope (AFM). The AFM is advantageously used in this invention because the configuration of the microscopic region can be precisely evaluated by the use of atomic force.

In this invention, the thickness of the spacer layer is preferably between 0.4 nm and 1.2 nm, more preferably between 0.5 nm and 1 nm. If the thickness of the spacer layer falls within the above-mentioned range, exchange coupling between the first and the second magnetic layers across the spacer layer is suitably performed so that the thermal fluctuation resistance can be improved. As will readily be understood, another layer may be formed between the spacer layer and each of the first and the second magnetic layers.

In this invention, each of the first and the second magnetic layers may comprise a plurality of magnetic layers.

In this invention, the second magnetic layer may be used as a magnetic recording layer. Preferably, however, a third magnetic layer is formed on the second magnetic layer. In this case, the third magnetic layer is formed on the exchange coupling film comprising the first magnetic layer, the spacer layer, and the second magnetic layer. With this structure, it is possible to use the first magnetic layer as a layer for controlling exchange coupling, the second magnetic layer as a layer for controlling exchange coupling and crystal orientation of the third magnetic layer, and the third magnetic layer as a magnetic recording layer. In this case, the crystal orientation of the third magnetic layer is improved so as to contribute to a higher recording density. If necessary, another layer for further promoting the crystal orientation may be formed between the second and the third magnetic layers.

In this invention, magnetic grains forming the magnetic recording layer preferably have an average grain size of 10 nm or less, more preferably 8 nm or less. At such a microscopic grain size, a high S/N ratio is obtained but thermal fluctuation is very likely to occur in the existing techniques. However, in this invention, the thermal fluctuation resistance is improved as described above and, therefore, the magnetic grains having such a microscopic grain size can be used as the magnetic recording layer so as to contribute to a higher recording density.

It is unnecessary to define a lower limit for the average grain size of the magnetic grains. However, if the grain size is smaller than 3 nm, the magnetic grains may become superparamagnetic, which is not preferable in practical use. Therefore, it is practically preferable that the average grain size of the magnetic grains has a lower limit of 3 nm.

In this invention, a magnetic layer material and a spacer layer material need not be restricted as far as the effect of this invention is not diminished.

In this invention, the spacer layer material is preferably a material having a higher melting point than that of the magnetic layer material. If the spacer layer material has a melting point lower than that of the magnetic layer material, the thickness of the spacer layer tends to be nonuniform in a microscopic region when the spacer layer is deposited. As a result, the surface roughness of the spacer layer may be increased. In particular, in case where the magnetic layer and the spacer layer are deposited by sputtering and if the spacer layer material has a melting point lower than that of the magnetic layer material, sputtered particles of the spacer layer material tend to migrate on the magnetic layer so that the surface roughness of the spacer layer tends to be large.

In this invention, the magnetic layer material is preferably a ferromagnetic material. The spacer layer material is preferably a nonmagnetic material. By the use of these materials, exchange coupling between the first and the second magnetic layers can suitably be controlled. In this point of view, if the magnetic layer material is a Co-based alloy ferromagnetic material, the spacer layer material is preferably a Ru metal or a Ru-based alloy nonmagnetic material.

As the Co-based alloy ferromagnetic material, use may be made of, for example, a CoPt-based alloy, a CoCr-based alloy, and a CoCrPt-based alloy. The CoPt-based alloy is preferable in view of the thermal fluctuation resistance because a high magnetic anisotropy constant Ku is obtained. The CoCr-based alloy or the CoCrPt-based alloy is preferable because high thermal fluctuation resistance is achieved. A CoCrPtTa-based alloy further containing Ta is preferable also. Among others, the CoCrPt-based alloy is preferable and a CoCrPtB-based alloy is particularly preferable as the magnetic layer material in this invention. By making the CoCrPt-based alloy contain B, the S/N ratio can further be improved. This alloy is particularly suitable for a higher recording density.

The material and the thickness of each of the first and the second magnetic layers may appropriately be adjusted within a range such that the effect of this invention is not diminished. In case where the third magnetic layer is formed, the material and the thickness of the third magnetic layer may appropriately be adjusted within a range such that the effect of this invention is not diminished.

In this invention, each of the first and the second magnetic layers is preferably formed in an epitaxial relationship with the spacer layer. In case of a nonepitaxial relationship, the surface roughness of the spacer layer may become large.

Therefore, the magnetic layer material and the spacer layer material preferably have the same crystal structure. In this event, each of the first and the second magnetic layers is easily formed in an epitaxial relationship with the spacer layer. In this point of view, each of the magnetic layers and the spacer layer is preferably formed by the use of a material having a hcp crystal structure.

In this invention, the exchange coupling film contained in the magnetic layer preferably causes antiferromagnetic coupling. Herein, the antiferromagnetic coupling is coupling such that the first magnetic layer has a magnetization direction antiparallel to that of the second magnetic layer. If the exchange coupling film causing antiferromagnetic coupling is used, it is possible to decrease the thickness of a layer effectively carrying a magnetic record while the activated volume V is maintained, i.e., without decreasing the thermal fluctuation resistance. Therefore, it is possible to suppress the medium noise N and to achieve a high S/N ratio.

Based on the above-mentioned knowledge, the present inventors further proceeded their study and found out the following. Since the surface roughness of the spacer layer depends upon the surface roughness of the disk substrate, the surface roughness of the spacer layer can be decreased relative to its thickness if the surface roughness Ra of the disk substrate is not greater than the thickness of the spacer layer. As a consequence, the variation in exchange coupling is suppressed and high thermal fluctuation resistance is achieved. This leads to completion of the invention in the structure 3. If the surface roughness Ra of the disk substrate exceeds the thickness of the spacer layer, it may sometimes be difficult to adjust the surface roughness of the spacer layer formed on the disk substrate to a desired surface roughness. On the other hand, if the surface roughness Ra of the disk substrate is not greater than the thickness of the spacer layer, a desired surface roughness of the spacer layer can be achieved.

In the invention of the structure 4, the surface roughness Ra of the disk substrate is not greater than 0.5 nm. It is supposed that, if the surface roughness of the disk substrate is not greater than 0.5 nm, the surface roughness of the spacer layer can similarly be reduced and variation in exchange coupling is suppressed. As a consequence, high thermal fluctuation resistance can be achieved. Further, it is supposed that, if the surface roughness Ra of the disk substrate is not greater than the thickness of the spacer layer and is not greater than 0.5 nm, the variation in exchange coupling is further suppressed. As a result, especially excellent thermal fluctuation resistance can be achieved.

Furthermore, if the surface roughness Ra of the disk substrate is not greater than 0.4 nm, the effect of this invention is more remarkable.

In this invention, in addition to limitation of the surface roughness Ra of the disk substrate, the surface roughness Rmax of the spacer layer is preferably not greater than 5 nm, more preferably not greater than 4 nm because the effect of this invention is more remarkable.

In this invention, it is unnecessary to determine a lower limit for the surface roughness Ra or Rmax of the disk substrate. As the disk substrate has a more flat and smooth surface, the effect of this invention is more remarkably exhibited. However, a practical lower limit may be determined, for example, in order to avoid degradation in HDI characteristics. In this point of view, it is practically preferable that the surface roughness Ra of the disk substrate has a lower limit of, for example, 0.05 nm and that the surface roughness Rmax has a lower limit of, for example, 0.5 nm. As the surface roughness of the disk substrate also, it is preferable to use a value measured by the atomic force microscope (AFM).

As a result of further study, the present inventors have found out that, by preliminarily obtaining the relationship between the surface roughness Ra of the disk substrate and the signal attenuation of the magnetic disk comprising the disk substrate and the magnetic layer formed thereon owing to the thermal fluctuation and determining the surface roughness Ra of the disk substrate with reference to the relationship so that the signal attenuation has a desired level, the magnetic disk of this invention can stably be obtained. Specifically, as set forth in the structure 8, it is possible to provide a method of producing a magnetic disk comprising a disk substrate and a magnetic layer formed thereon, the magnetic layer comprising an exchange coupling film including a first magnetic layer, a second magnetic layer, and a spacer layer interposed between the first and the second magnetic layers, the method comprising the steps of preliminarily obtaining the relationship between the surface roughness Ra of the disk substrate and the signal attenuation or decay of the magnetic disk owing to thermal fluctuation and determining the surface roughness Ra of the disk substrate with reference to the relationship so that the signal attenuation has a desired level. According to this method, it is possible to economically and stably mass-produce a magnetic disk excellent in thermal fluctuation resistance and high in S/N ratio and suitable for a higher recording density.

In the structure 8, Ra is used as the surface roughness. It is noted here that, without being limited to Ra, a different index, such as Rmax, generally used to represent the surface roughness may be used. The structure 8 utilizes the fact that, by obtaining the relationship between the surface roughness of the disk substrate and the signal attenuation owing to thermal fluctuation, the relationship between the surface roughness of the spacer layer and the signal attenuation owing to thermal fluctuation is indirectly obtained. Alternatively, the relationship between the surface roughness of the spacer layer and the signal attenuation owing to thermal fluctuation may be directly obtained.

In order to obtain the magnetic disk of this invention, use may be made of, for example, the method set forth in the structure 11. Specifically, according to this invention, there is provided a method of producing a magnetic disk comprising a disk substrate and a magnetic layer formed thereon, the magnetic layer comprising an exchange coupling film including a first magnetic layer, a second magnetic layer, and a spacer layer interposed between the first and the second magnetic layers, the method comprising the step of depositing the spacer layer by sputtering so that the surface roughness Ra of the spacer layer is smaller than the thickness of the spacer layer.

In the deposition by sputtering, the surface roughness of a film to be deposited and the degree of epitaxy can be controlled by controlling a sputtering condition including the deposition rate, the deposition temperature, the vacuum degree, the bias potential, and so on. Therefore, by adjusting the sputtering condition so that the surface roughness Ra of the spacer layer is smaller than the thickness of the spacer layer, the magnetic disk of this invention can suitably be produced. Among others, it is advantageous to adjust the deposition rate of the spacer layer to a predetermined deposition rate. Specifically, the deposition rate within a range lower than 1.2 nm/sec is preferable. The lower limit of the deposition rate need not specifically be determined. However, in practical production, the deposition rate not lower than 0.1 nm/sec is preferable. The deposition temperature preferably falls within a range not higher than 260° C. The lower limit is the room temperature. In case where the spacer layer is deposited at the deposition rate and the deposition temperature mentioned above, it is preferable to select as the spacer layer material a Ru metal or a Ru-based alloy nonmagnetic material which is a high-melting-point material. In this case, the spacer layer has an especially flat and smooth surface and is promoted to have an epitaxial relationship with the magnetic layer.

In this invention, a glass substrate is preferably used as the disk substrate. This is because the surface of the glass substrate can be finished into a high-precision flat and smooth surface so as to reduce the surface roughness of the spacer layer in the exchange coupling film formed thereon. The glass includes an amorphous glass, a crystallized glass, and so on. Particularly, the amorphous glass is suitable in this invention because of its amorphous nature and high surface flatness and smoothness. As a material of the glass substrate, use may be made of, for example, an aluminosilicate glass, a soda lime glass, a soda aluminosilicate glass, an aluminoborosilicate glass, a borosilicate glass, a silica glass, and a chain silicate glass. Among others, the aluminosilicate glass is suitable in this invention because a high-precision flat and smooth surface is obtained and because high rigidity is obtained by chemical strengthening. The thickness of the glass substrate is not particularly limited but is preferably between about 0.1 mm and 1.5 mm.

In this invention, it is preferable to form a functional underlayer if appropriate. Such a functional underlayer may be a miniaturization promoting layer having a function of miniaturizing grains in an upper layer, a seed layer having a function of uniformly miniaturizing grains in an upper layer, an underlayer having a function of imparting orientation to crystal grains in the magnetic layer, and an intermediate layer having a function of improving the orientation of the crystal grains in the magnetic layer. It is noted here that these functional underlayers are preferably formed without irregularities.

As the miniaturization promoting layer, it is preferable to use an amorphous metal film so as to miniaturize the grains of the upper layer such as the seed layer. For example, use may be made of a CrTi-based alloy film and a CrTa-based alloy film. Among others, the CrTi-based alloy film is particularly preferable because the amorphous metal film containing microcrystals is formed.

As the seed layer, it is preferable to use a metal film having a bcc or a B2 crystal structure so as to uniformly miniaturize the grains of the upper layer such as the underlayer. For example, use may be made of an alloy having a bcc or a B2 crystal structure, such as an Al-based alloy, a Cr-based alloy, a NiAl-based alloy, a NiAlB-based alloy, an AlRu-based alloy, an AlRuB-based alloy, an AlCo-based alloy, and a FeAl-based alloy so as to achieve miniaturization of the magnetic grains. Among others, the AlRu-based alloy film is preferable because it is excellent in miniaturization of the magnetic grains.

As the underlayer, a Cr-based alloy film having a bcc crystal structure is preferable. For example, a CrMo-based alloy, a CrV-based alloy, a CrW-based alloy, and a CrTi-based alloy may be used.

As the intermediate layer, a Co-based alloy film having a hcp crystal structure is preferable.

The magnetic disk of this invention preferably has a protection layer and a lubrication layer on the magnetic layer if appropriate. As the protection layer, a carbon-based protection layer is advantageous. As the lubrication layer, a perfluoropolyether compound is advantageous, for example.

In this invention, deposition of each of the above-mentioned layers may be carried out by the use of a known technique. For example, sputtering (DC magnetron sputtering, RF sputtering, and so on) and plasma CVD may be used. The lubrication layer may formed by a known technique, such as dipping, spraying, and spin coating.

In this invention, the magnetic disk preferably has a coercive force Hc not smaller than 2500 Oersteds. If the coercive force is not smaller than 2500 Oersteds, the magnetic anisotropy constant Ku has a sufficient value.

Now, description will be made of this invention in conjunction with several specific examples. It is noted here that this invention is not limited to the following examples.

### EXAMPLE 1

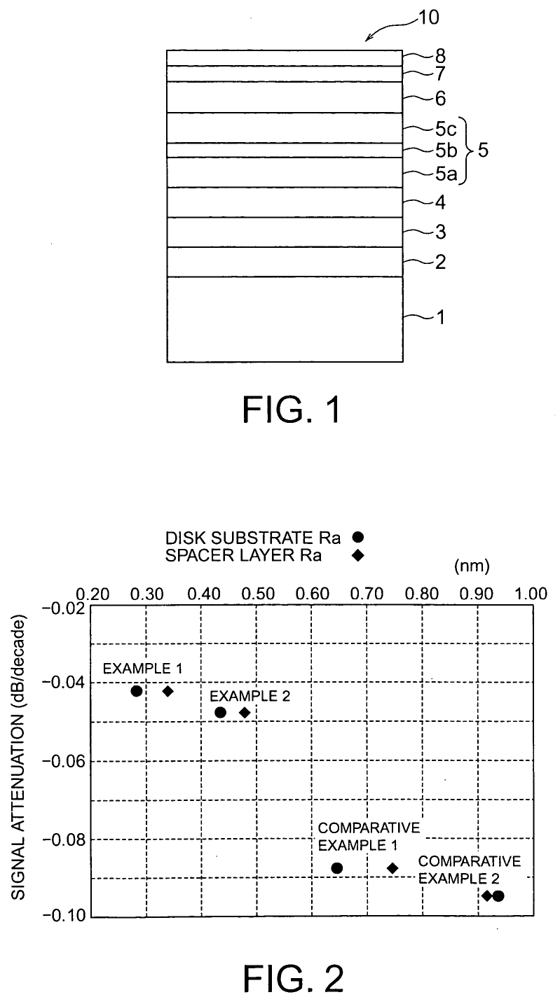

Referring to FIG. 1, a magnetic disk 10 in this example comprises a glass substrate 1 with a miniaturization promoting layer 2, a seed layer 3, an underlayer 4, an exchange coupling film 5, a third magnetic layer 6, a protection layer 7, and a lubrication layer 8 successively formed thereon. The exchange coupling film 5 comprises a first magnetic layer 5a, a spacer layer 5b formed on the first magnetic layer 5a, and a second magnetic layer 5c formed on the spacer layer 5b.

Next, description will be made of a method of producing the magnetic disk 10 in this example.

At first, a molten glass was subjected to direct pressing by the use of an upper die, a lower die, and a body die to obtain a disk-shaped glass substrate made of an aluminosilicate glass and having a diameter of 66 mmφ and a thickness of 1.5 mm. The glass substrate was subjected to grinding, precision polishing, end-face polishing, precision cleaning, and chemical strengthening. As a consequence, a magnetic disk glass substrate 1 having a flat and smooth substrate surface and a high rigidity was produced. The precision polishing was carried out by the use of an abrasive liquid containing colloidal silica abrasive grains so as to achieve a high flatness and smoothness of the substrate surface of the glass substrate 1.

By the use of an atomic force microscope (AFM), the surface roughness of the substrate surface of the glass substrate 1 obtained through the above-mentioned process was measured. As a result, it was confirmed that the magnetic disk glass substrate 1 had an ultraflat and ultrasmooth substrate surface having an average roughness Ra=0.29 nm and an average roughness (maximum height) Rmax=2.93 nm. Ra and Rmax were obtained in accordance with JIS B0601 (the same applies to the following description). As a result of observation by the AFM, no irregularities, such as texture, were observed. The glass substrate 1 thus obtained was a 2.5-inch magnetic disk substrate having an outer diameter of 65 mm, an inner diameter of 20 mm, and a thickness of 0.635 mm.

Next, by the use of a fixed-target sputtering deposition apparatus, each layer was deposited on the glass substrate 1.

At first, by the use of a target of a nonmagnetic CrTi alloy, the miniaturization promoting layer 2 of the CrTi alloy was deposited on the glass substrate 1 to the thickness of 30 nm. The miniaturization promoting layer 2 forms an amorphous metal film containing microcrystals. Next, by the use of a nonmagnetic AlRu (Al: 50 at %, Ru: 50 at %) alloy as a sputtering target, the seed layer 3 of the AlRu alloy having a thickness of 20 nm was deposited on the miniaturization promoting layer 2. The seed layer 3 had a B2 crystal structure. Then, by the use of a nonmagnetic CrW (Cr: 85 at %, W: 15 at %) alloy as a sputtering target, the underlayer 4 of the CrW alloy having a thickness of 10 nm was deposited on the seed layer 3. The underlayer 4 had a bcc crystal structure.

Next, the exchange coupling film 5 causing antiferromagnetic coupling was deposited on the underlayer 4. At first, by the use of a target of a ferromagnetic CoCr alloy having a hcp crystal structure, the first magnetic layer 5a made of the CoCr alloy (Co: 88 at %, Cr: 12 at %) and having a hcp crystal structure was epitaxially deposited on the underlayer 4 to the thickness of 2.5 nm. The CoCr alloy had a melting point of about 1450° C. Then, by the use of a target of a nonmagnetic Ru metal having a hcp crystal structure, the spacer layer 5b made of the Ru metal and having a hcp crystal structure was epitaxially deposited on the first magnetic layer 5a to the thickness of 0.7 nm. The Ru metal had a melting point of about 2250° C. The surface roughness of an upper surface (namely, a principal surface ) of the spacer layer 5b was measured by the atomic force microscope (AFM). As a result, the average roughness Ra of the upper surface (or the principal surface) of the spacer layer 5b was equal to 0.34 nm and the average roughness (maximum height) Rmax of the upper surface (or the principal surface) of the spacer layer 5b was equal to 3.41 nm. Thus, it is understood that the surface roughness Ra of the upper surface (or the principal surface) of the spacer layer 5b is not greater than the thickness (0.7 nm) of the spacer layer 5b and that the spacer layer 5b has a flat and smooth upper (or principal) surface.

Then, by the use of a target of a ferromagnetic CoCrPtTa (Co: 70 at %, Cr: 19 at %, Pt: 9 at %, Ta: 2 at %) alloy having a hcp crystal structure, the second magnetic layer 5c made of the CoCrPtTa alloy and having a hcp crystal structure was epitaxially deposited on the spacer layer 5b to the thickness of 1 nm. The CoCrPtTa alloy had a melting point of about 1450° C. The magnetization directions of the first and the second magnetic layers 5a and 5c are controlled to cause antiparallel coupling by interposition of the spacer layer 5b and by magnetization of these layers.

Then, by the use of a target of a ferromagnetic CoCrPtB (Co: 61 at %, Cr: 20 at %, Pt: 12 at %, B: 7 at %) alloy having a hcp crystal structure, the third magnetic layer 6 made of the CoCrPtB alloy and having a hcp crystal structure was epitaxially deposited on the exchange coupling film 5 to the thickness of 15 nm. The CoCrPtB alloy had a melting point of about 1450° C. The third magnetic layer 6 has a function as a magnetic recording layer.

Next, on the third magnetic layer 6, the protection layer 7 of hydrogenated amorphous carbon was deposited to the thickness of 5 nm. The protection layer 7 serves to protect the third magnetic layer 6 from the impact of a magnetic head flying over the magnetic disk 10. The magnetic disk 10 with the protection layer 7 formed on its top was taken out from the sputtering deposition apparatus. By dipping, the lubrication layer 8 containing a PFPE (perfluoropolyether) compound was deposited to the thickness of 1 nm. The lubrication layer 8 serves to mitigate and soften the contact with the magnetic head flying over the magnetic disk 10.

In the above-mentioned manner, the magnetic disk 10 in this example was produced.

The magnetic disk 10 thus obtained was observed by a TEM (transmission electron microscope). As a result, the third magnetic layer 6 (magnetic recording layer) 6 had an average grain size of 8 nm. Herein, the average grain size is obtained by analyzing the sizes of a number of grains on the surface of the magnetic recording layer as observed in plan view by the TEM and calculating the average. The magnetic disk 10 was also observed in section by the TEM. As a result, the underlayer 4, the exchange coupling film 5, and the third magnetic layer 6 were epitaxially formed.

The magnetic characteristics of the magnetic disk 10 were evaluated by the use of a VSM (vibrating sample magnetometer). As a result, the magnetization curve exhibited antiferromagnetic exchange coupling. The coercive force Hc was 2850 Oersteds.

Next, evaluation was made of thermal fluctuation of the magnetic disk 10. The evaluation was carried out in the following manner. The magnetic disk 10 was held under the environment of 60° C. By the use of a GMR (giant magnetoresistance) head having a write track width of 2.0 μm, a read track width of 0.5 μm, a flying height of 20 nm, a signal was recorded as a recorded signal in the magnetic disk at a linear recording density of 100 kFCl (kilo flux change per inch). Then, the signal attenuation of the recorded signal with lapse of time was evaluated by a spectroanalyzer. As the signal attenuation per unit time is greater, the magnetic disk is more easily susceptible to thermal fluctuation and is lower in thermal fluctuation resistance. For the magnetic disk having a recording density of 40 Gbit/inch² or more, an upper limit of the thermal fluctuation is supposed to be −0.08 dB/decade in terms of the signal fluctuation evaluated in the above-mentioned manner. The above-mentioned value of the upper limit is often used as a predetermined standard.

In the above-mentioned manner, the magnetic disk 10 in this example was evaluated for thermal fluctuation. As a result, the signal attenuation was −0.042 dB/decade which sufficiently met the predetermined standard mentioned above.

Next, the recording/reproducing characteristics (RAN (Read/Write) characteristics) were evaluated. Specifically, the medium noise N of the magnetic disk was obtained by recording a carrier signal at a recording density (1 F (1st frequency)) of 700 kFCl and thereafter calculating an integrated medium noise over a range of DC to 1 F×1.2 times frequency. The reproduction output S was obtained as a reproduction output of a signal recorded at a 12 F (58 kFCl) recording density. The magnetic head used in recording/reproducing operations had a flying height of 15 nm. The reproducing device was a GMR device. As a result of evaluation, the magnetic disk 10 in this example had a S/N ratio of 28.8 dB. The S/N ratio satisfied a desired value for the magnetic disk having a high recording density not smaller than 40 Gbit/inch².

In FIG. 2, the relationship between the surface roughness Ra of the disk substrate and the signal attenuation owing to thermal fluctuation in this example was plotted (●). Further, the relationship between the surface roughness Ra of the spacer layer and the signal attenuation owing to thermal fluctuation was also plotted (♦).

### EXAMPLE 2

In Example 2, a disk substrate was produced in the manner similar to Example 1 except that precision polishing was carried out by the use of colloidal silica abrasive grains different in grain size from those in Example 1. The disk substrate obtained in Example 2 was a glass substrate having the surface roughness Ra of 0.44 nm and Rmax of 4.50 nm. On the disk substrate, deposition of layers was carried out in the manner similar to Example 1 to obtain a magnetic disk in Example 2. The surface roughness of the spacer layer 5b in this example was evaluated in the manner similar to Example 1. As a result, Ra was equal to 0.48 nm and Rmax was equal to 5.13 nm. Thus, it is understood that the surface roughness Ra of the spacer layer 5b is not greater than the thickness (0.7 nm) of the spacer layer 5b and the spacer layer 5b had a flat and smooth surface.

The magnetic disk in Example 2 was subjected to TEM analysis and VSM evaluation and the results similar to those in Example 1 were obtained.

Furthermore, the magnetic disk in Example 2 was evaluated for thermal fluctuation in the manner similar to Example 1. As a result, the signal attenuation was −0.048 dB/decade, which sufficiently met the predetermined standard. The magnetic disk in Example 2 had an S/N ratio of 28.5 dB.

In. FIG. 2, the relationship between the surface roughness Ra of the disk substrate and the signal attenuation owing to thermal fluctuation in Example was plotted (●). Further, the relationship between the surface roughness Ra of the spacer layer and the signal attenuation owing to thermal fluctuation was also plotted (♦).

### COMPARATIVE EXAMPLES 1 AND 2

In Comparative Examples 1 and 2, disk substrates were produced in the manner similar to Example 1 except that abrasive grains in precision polishing were changed from the colloidal silica abrasive grains in Example 1 into cerium oxide abrasive grains. The disk substrate obtained in Comparative Example 1 was a glass substrate having the surface roughness Ra of 0.65 nm and Rmax of 6.99 nm. The disk substrate obtained in Comparative Example 2 was a glass substrate having the surface roughness Ra of 0.93 nm and Rmax of 9.40 nm.

On the disk substrates thus obtained, deposition of layers was carried out in the manner similar to Example 1. Thus, magnetic disks in Comparative Examples 1 and 2 were obtained. The surface roughness of the spacer layer 5b in each of Comparative Examples 1 and 2 was evaluated in the manner similar to Example 1. As a result, Ra was equal to 0.75 nm and Rmax was equal to 7.20 nm in Comparative Example 1. Ra was equal to 0.92 nm and Rmax was equal to 9.59 nm in Comparative Example 2. Thus, it is understood that the surface roughness Ra of the spacer layer 5b exceeds the thickness (0.7 nm) of the spacer layer 5b in each of Comparative Examples 1 and 2 and, therefore, the spacer layer 5b had a relatively rough surface.

The magnetic disks in Comparative Examples 1 and 2 were subjected to TEM analysis and VSM evaluation. The results similar to those of Example 1 were obtained.

Further, the magnetic disks in Comparative Examples 1 and 2 were evaluated for thermal fluctuation in the manner similar to Example 1. As a result, the signal attenuation was −0.088 dB/decade in Comparative Example 1 and −0.095 dB/decade in Comparative Example 2. Thus, it is understood that the signal attenuation owing to thermal fluctuation was larget. The magnetic disks in Comparative Examples 1 and 2 had the S/N ratio of 28.5 dB in Comparative Example 1 and 28.3 dB in Comparative Example 2.

In FIG. 2, the relationship between the surface roughness Ra of the disk substrate and the signal attenuation owing to thermal fluctuation in each of Comparative Examples was plotted (●). Further, the relationship between the surface roughness Ra of the spacer layer and the signal attenuation owing to thermal fluctuation was also plotted (♦).

Comparison will be made between Examples 1 and 2 and Comparative Examples 1 and 2. In Examples 1 and 2 of this invention, the thermal fluctuation resistance is remarkably improved and, simultaneously, a high S/N ratio is maintained. Thus, it is understood that the tradeoff between the thermal fluctuation resistance and the S/N ratio suffered in the existing advanced techniques could be overcome. On the other hand, in Comparative Examples 1 and 2, the surface roughness of each of the disk substrate and the spacer layer is relatively large so that the variation in exchange coupling occurs and the thermal fluctuation resistance is poor.

In the meanwhile, FIG. 2 plotting the results of Examples shows the relationship between the surface roughness Ra of the disk substrate and the signal attenuation of the magnetic disk comprising the disk substrate and the magnetic layer formed thereon owing to thermal fluctuation. With reference to the relationship, it is possible to determine the surface roughness Ra of the disk substrate so that the signal attenuation has a desired level. By precision polishing, the glass disk substrate having the surface roughness thus determined is produced. On the disk substrate, the magnetic layer including the exchange coupling film and other layers are formed. Thus, it is possible to economically and stably mass-produce a magnetic disk excellent in thermal fluctuation and high in S/N ratio and suitable for a higher recording density.

### EXAMPLE 3

In Example 3, the first magnetic layer 5a comprises a plurality of magnetic layers so as to improve the degree of exchange coupling of the exchange coupling film 5 for the purpose of further enhancement of the thermal fluctuation resistance. With this structure, it is possible to enhance the effect of the first magnetic layer 5a for controlling the exchange coupling.

Specifically, a magnetic disk was produced in the manner similar to Example 1 except that, between the underlayer 4 and the first magnetic layer 5a of a ferromagnetic CoCr alloy, an additional magnetic layer made of a ferromagnetic CoCrPtTa (Co: 70 at %, Cr: 19 at %, Pt: 9 at %, Ta: 2 at %) alloy and having a hcp crystal structure was formed. The additional magnetic layer was epitaxially deposited to the thickness of 1 nm by sputtering using a ferromagnetic CoCrPtTa alloy having a hcp crystal structure. The CoCrPtTa alloy had a melting point of about 1450° C. A combination of the additional magnetic layer of the CoCrPtTa alloy and the magnetic layer of the ferromagnetic CoCr alloy (the first magnetic layer 5a in Example 1) serves as the first magnetic layer 5a having a two-layer structure.

It is understood that, in Example 3, the surface roughness Ra (0.34 nm) of the spacer layer 5b is not greater than the thickness (0.7 nm) of the spacer layer 5b and the spacer layer 5b has a flat and smooth surface.

The magnetic disk in Example 3 was subjected to TEM analysis and VSM evaluation. The results were similar to those in Example 1.

The magnetic disk in Example 3 was evaluated for thermal fluctuation in the manner similar to Example 1. As a result, the signal attenuation was −0.040 dB/decade, which corresponds to ½ of the predetermined standard. Thus, excellent thermal fluctuation resistance was exhibited. The magnetic disk in Example 3 had the S/N ratio of 28.8 dB.

### EXAMPLES 4 TO 7

Next, magnetic disks were produced by the use of a glass substrate 1 similar to that of Example 1 (the glass substrate having the surface roughness Ra of 0.28 nm and Rmax of 2.91 nm). By selecting various sputtering deposition conditions for the spacer layer 5b, the magnetic disks different in surface roughness of the spacer layer 5b were produced. Specifically, the deposition rate and the deposition temperature upon sputtering deposition of the spacer layer 5b were adjusted. Except the above, the magnetic disks were produced in the manner similar to Example 1. The results are shown in Table 1.

TABLE 1

| | | | | | average | | |
|---|---|---|---|---|---|---|---|
| | deposition condition of | | surface | | grain | | |
| | spacer layer | | roughness of | | size of | | |
| | deposition | deposition | spacer layer | | magnetic | signal | S/N |
| Exam- | temperature | rate | Rmax | Ra | layer | attenuation | ratio |
| ples | (° C.) | (nm/sec) | (nm) | (nm) | (nm) | (dB/decade) | (dB) |
| 4 | 260 | 0.4 | 3.51 | 0.35 | 8 | −0.043 | 28.8 |
| 5 | 320 | 0.4 | 3.70 | 0.36 | 11 | −0.045 | 28.0 |
| 6 | 260 | 1.2 | 5.03 | 0.51 | 8 | −0.049 | 28.5 |
| 7 | 100 | 1.5 | 6.85 | 0.69 | 10 | −0.075 | 28.3 |

As a result, the effect of this invention is particularly remarkable in case of the magnetic disk in which the magnetic layer (magnetic recording layer) has an average grain size not greater than 10 nm. According to this invention, it is possible to achieve excellent thermal fluctuation characteristic while a high S/N ratio is maintained. Therefore, this invention is particularly advantageous in case where the magnetic disk is used in applications requiring the average grain size not greater than 10 nm.

Upon production of the magnetic disk of this invention, the deposition rate of the spacer layer is preferably as slow as 1.2 nm/sec or less. For example, in case of 1.5 nm/sec, the signal attenuation owing to thermal fluctuation is −0.075 dB/decade, which leaves only a small margin from the predetermined standard. The deposition temperature not higher than 260° C. achieves a particularly excellent S/N ratio.

As described above, according to this invention, it is possible to obtain a magnetic disk prevented from thermal fluctuation and having a high S/N ratio even at a high recording density of 40 Gbit/inch² or more.

According to this invention, it is possible to economically and stably mass-produce a magnetic disk which is excellent in thermal fluctuation resistance and high in S/N ratio and is therefore suitable for a higher recording density.

Although this invention has thus far been described in conjunction with several specific examples, it will readily be possible for those skilled in the art to put this invention into practice in various other manners without departing the scope of appended claims.

What is claimed is:

1. A magnetic disk comprising a disk substrate having a substrate surface and an exchange coupling film on said substrate surface, said exchange coupling film comprising a first magnetic layer, a second magnetic layer farther from said substrate surface than said first magnetic layer, and a spacer layer interposed between said first and said second magnetic layers and having a principal surface nearer to said second magnetic layer than said first magnetic layer, said principal surface of the spacer layer having a surface roughness Ra which is not greater than a thickness of said spacer layer, where Ra is representative of a center-line-mean roughness.

2. A magnetic disk comprising a disk substrate having a substrate surface and an exchange coupling film on said substrate surface, said exchange coupling film comprising a first magnetic layer, a second magnetic layer farther from said substrate surface than said first magnetic layer, and a spacer layer interposed between said first and said second magnetic layers and having a principal surface nearer to said second magnetic layer than said first magnetic layer, said principal surface of the spacer layer having a surface roughness Ra which is not greater than 0.5 nm, where Ra is representative of a center-line-mean roughness.

3. A magnetic disk comprising a disk substrate having a substrate surface and an exchange coupling film on said substrate surface, said exchange coupling film comprising a first magnetic layer, a second magnetic layer farther from said substrate surface than said first magnetic layer, and a spacer layer interposed between said first and said second magnetic layers, said substrate surface of the disk substrate having a surface roughness Ra which is not greater than a thickness of said spacer layer, where Ra is representative of a center-line-mean roughness.

4. A magnetic disk comprising a disk substrate having a substrate surface and an exchange coupling film on said substrate surface, said exchange coupling film comprising a first magnetic layer, a second magnetic layer farther from said substrate surface than said first magnetic layer, and a spacer layer interposed between said first and said second magnetic layers, said substrate surface of the disk substrate having a surface roughness Ra which is not greater than 0.5 nm, where Ra is representative of a center-line-mean roughness.

5. A magnetic disk as claimed in any one of claims 1 through 4, wherein said spacer layer is made of a high-melting-point material higher in melting point than a material of any one of said first and said second magnetic layers.

6. A magnetic disk as claimed in any one of claims 1 through 4, wherein each of the first and the second magnetic layers has an epitaxial relationship with the spacer layer.

7. A magnetic disk as claimed in any one of claims 1 through 4, wherein the exchange coupling film causes antiferromagnetic coupling.

8. A method of producing a magnetic disk comprising a disk substrate having a substrate surface and an exchange coupling film on said substrate surface, said exchange coupling film comprising a first magnetic layer, a second magnetic layer farther from said substrate surface than said first magnetic layer, and a spacer layer interposed between said first and said second magnetic layers, said method comprising the steps of:
preliminarily obtaining a relationship between a surface roughness of the substrate surface of said disk substrate and attenuation owing to thermal fluctuation when a signal is recorded on said magnetic disk;
determining a desired surface roughness of the substrate surface of said disk substrate with reference to said relationship so that the attenuation of said signal has a desired level,
producing the disk substrate having the substrate surface which has the desired surface roughness; and
forming the exchange coupling film on the substrate surface of the disk substrate which has the desired surface roughness.

9. A method of producing a magnetic disk comprising a disk substrate having a substrate surface and an exchange coupling film on said substrate surface, said exchange coupling film comprising a first magnetic layer, a second magnetic layer farther from said substrate surface than said first magnetic layer, and a spacer layer interposed between said first and said second magnetic layers and having a principal surface nearer to said second magnetic layer than said first magnetic layer, said method comprising the step of:
depositing said spacer layer by sputtering so that said principal surface of the spacer layer has a surface roughness Ra which is not greater than a thickness of said spacer layer, where Ra is representative of a center-line-mean roughness.

10. A method of producing a magnetic disk as claimed in claim 9, wherein said spacer layer is deposited by sputtering at a deposition rate within a range not higher than 1.2 nm/sec.
